(19) United States
(12) Patent Application Publication
(10) Pub. No.: US 2013/0129363 A1
(43) Pub. Date: May 23, 2013

(54) IMAGE FORMING APPARATUS HAVING INTEGRATED SENSING UNIT

(71) Applicant: Samsung Electronics Co., Ltd., Suwon (KR)

(72) Inventors: Ki-hun KIM, Yongin (KR); Kwan-ho Kang, Suwon (KR); Jin-soo Lee, Suwon (KR); Seung-jin Jung, Suwon-si (KR)

(73) Assignee: Samsung Electronics Co., Ltd., Suwon (KR)

(21) Appl. No.: 13/679,246

(22) Filed: Nov. 16, 2012

(30) Foreign Application Priority Data
Nov. 18, 2011 (KR) 10-2011-0120925

(51) Int. Cl. G03G 15/00

(52) U.S. Cl. CPC G03G 15/55
USPC 399/16

(57) ABSTRACT

An image forming apparatus is provided. The apparatus includes an integrated sensing unit, which includes an optical sensor including a light emitting part and a light receiving part to receive light emitted from the light emitting part, and an actuator which selectively blocks light to be received by the light receiving part. The actuator includes a shaft member that is elastically supported in one rotation direction, a light blocking member that is mounted on the shaft member and is selectively positioned between the light emitting part and the light receiving part, and a first contact member and a second contact member distanced from each other on the shaft member.

### CROSS-REFERENCE TO RELATED APPLICATIONS

This application is related to and claims priority to Korean Patent Application No. 10-2011-0120925, filed on Nov. 18, 2011 in the Korean Intellectual Property Office, the disclosure of which is incorporated herein by reference in its entirety.

### BACKGROUND

1. Field

Embodiments discussed herein relate to an image forming apparatus, and more particularly, to an image forming apparatus having an integrated sensing unit.

2. Description of the Related Art

Image forming apparatuses using an electrophotographic image forming method (for example, printers, copiers, or facsimile machines) include a printing medium supply unit to supply printing media on which an image is to be formed. The printing media in the printing medium supply unit may be picked up by a pickup unit and supplied to a main body of the image forming apparatus.

A printing medium presence/absence sensing unit to sense whether the printing medium supply unit is empty and a printing medium size sensing unit to identify a size of a printing medium picked up from the printing medium supply unit may be provided in the proximity of the printing medium supply unit. In general, the printing medium presence/absence sensing unit includes one sensor and one actuator to change an operation of the sensor according to wherein printing media exist. Similarly, the printing medium size sensing unit generally includes one sensor and one actuator.

A related-art image forming apparatus senses presence/absence of a printing medium and a size of a printing medium separately and requires a plurality of sensors and a plurality of actuators in total to perform the plurality of functions.

### SUMMARY

Additional aspects and/or advantages will be set forth in part in the description which follows and, in part, will be apparent from the description, or may be learned by practice of the invention.

According to an exemplary embodiment an image forming apparatus is provided that can sense both a presence/absence of a printing medium and a size of a printing medium with a less complex structure than that of a related-art image forming apparatus.

According to an aspect of an exemplary embodiment, an image forming apparatus is provided that includes an integrated sensing unit that senses a presence/absence of paper in a printing medium supply unit and a size of paper picked up from the printing medium supply unit, collectively. The integrated sensing unit may include an optical sensor that includes a light emitting part and a light receiving part to receive light emitted from the light emitting part, and an actuator which selectively blocks light to be received by the light receiving part. The actuator may include a shaft member that is elastically supported in one rotation direction, a light blocking member that is mounted on the shaft member and is selectively positioned between the light emitting part and the light receiving part, and a first contact member and a second contact member which are distanced from each other on the shaft member. The first contact member may rotate the light blocking member on the shaft member in the other rotation direction opposite to the one rotation direction by contact with paper supplied to the printing medium supply unit, thereby reversing a light receiving state of the light receiving part, and the second contact member may further rotate the light blocking member on the shaft member in the other rotation direction by contact with paper of a size larger than a pre-defined size picked up from the printing medium supply unit, thereby reversing the light receiving state of the light receiving part.

The image forming apparatus may include a control unit which determines a presence/absence of paper and a size of paper based on a signal provided by the optical sensor.

The light blocking member may be positioned in a first position if the printing medium supply unit is empty, may be moved from the first position to a second position if the first contact member contacts paper supplied to the printing medium supply unit, and may be moved from the second position to a third position if the second contact member contacts paper of a size larger than the pre-defined size picked up from the printing medium supply unit. A light receiving state of the light receiving part when the light blocking member is positioned in the second position may be the reverse of a light receiving state of the light receiving part when the light blocking member is positioned in the first position and the third position.

The light blocking member may be positioned to block light to be received by the light receiving part when being positioned in the first position and the third position, and may be positioned to allow light to be received by the light receiving part when being positioned in the second position.

If an OFF signal generated by the optical sensor is retained longer than a first reference time, the control unit may determine that the printing medium supply unit is empty.

If an OFF signal generated by the optical sensor is retained shorter than a second reference time, the control unit may determine that paper picked up from the printing medium supply unit is paper of a size larger than the pre-defined size.

The second reference time may be shorter than the first reference time.

The light blocking member may include a first blocking portion which is positioned between the light emitting part and the light receiving part when the light blocking member is positioned in the first position, and a second blocking portion which is positioned between the light emitting part and the light receiving part when the light blocking member is positioned in the third position.

If the light blocking member is positioned in the second position, the optical sensor may be positioned between the first blocking portion and the second blocking portion.

The first blocking portion and the second blocking portion may form an acute angle therebetween.

The light blocking member may be positioned to allow light to be received by the light receiving part when being positioned in the first position and the third position, and may be positioned to block light to be received by the light receiving part when being positioned in the second position.

If an ON signal generated by the optical sensor is retained longer than a first reference time, the control unit may determine that the printing medium supply unit is empty.

If an ON signal generated by the optical sensor is retained shorter than a second reference time, the control unit may determine that paper picked up from the printing medium supply unit is paper of a size larger than the pre-defined size.

The second reference time may be shorter than the first reference time.

The light blocking member may include a body portion which is connected to the shaft member, and a blocking portion which extends from the body portion and is positioned between the light emitting part and the light receiving part only if the light blocking member is positioned in the second position.

The paper of the size larger than the pre-defined size may be A4 paper or letter paper.

The light blocking member may be disposed between the first contact member and the second contact member on the shaft member.

The light blocking member, the first contact member and the second contact member may be integrally formed with the shaft member.

According to an aspect of an exemplary embodiment, an image forming apparatus is provided that includes an integrated sensing unit which senses presence/absence of paper in a printing medium supply unit and a size of paper picked up from the printing medium supply unit, collectively. The integrated sensing unit may include: an optical sensor which includes a light emitting part and a light receiving part to receive light emitted from the light emitting part, and an actuator which selectively blocks light to be received by the light receiving part. The actuator may include: a shaft member which is elastically supported in one rotation direction, a light blocking member which is mounted on the shaft member and is selectively positioned between the light emitting part and the light receiving part, and a first contact member and a second contact member which are distanced from each other on the shaft member. The light blocking member may be positioned in a first position if the printing medium supply unit is empty, may be moved from the first position to a second position if the first contact member contacts paper supplied to the printing medium supply unit, and may be moved from the second position to a third position if the second contact member contacts paper picked up from the printing medium supply unit. The light blocking member may block light to be received by the light receiving part when being positioned in the first position and the third position, and may allow light to be received by the light receiving part when being positioned in the second position.

According to an aspect of an exemplary embodiment, an image forming apparatus is provided that includes an integrated sensing unit which senses presence/absence of paper in a printing medium supply unit and a size of paper picked up from the printing medium supply unit, collectively. The integrated sensing unit may include an optical sensor which includes a light emitting part and a light receiving part to receive light emitted from the light emitting part, and an actuator which selectively blocks light to be received by the light receiving part. The actuator may include a shaft member which is elastically supported in one rotation direction, a light blocking member which is mounted on the shaft member and is selectively positioned between the light emitting part and the light receiving part, and a first contact member and a second contact member which are distanced from each other on the shaft member. The light blocking member may be positioned in a first position if the printing medium supply unit is empty, may be moved from the first position to a second position if the first contact member contacts paper supplied to the printing medium supply unit, and may be moved from the second position to a third position if the second contact member contacts paper picked up from the printing medium supply unit. The light blocking member may allow light to be received by the light receiving part when being positioned in the first position and the third position, and may block light to be received by the light receiving part when being positioned in the second position.

### BRIEF DESCRIPTION OF THE DRAWINGS

The above and/or other aspects will be more apparent by describing in detail exemplary embodiments, with reference to the accompanying drawings, in which:

FIG. 1 illustrates an image forming apparatus according to an exemplary embodiment;

FIGS. 2A and 2B illustrate an integrated sensing unit when a printing medium supply unit is empty;

FIG. 3 illustrates an exemplary integrated sensing unit when a printing medium is supplied to the printing medium supply unit;

FIGS. 4A and 4B illustrate an exemplary integrated sensing unit if a printing medium of a large size is picked up;

FIG. 5 illustrates the integrated sensing unit according to an exemplary embodiment when the picking up of the printing medium of the large size is completed;

FIGS. 6A and 6B illustrate the integrated sensing unit according to an exemplary embodiment if a printing medium of a small size is picked up;

FIG. 7 illustrates an exemplary integrated sensing unit when printing media in the printing medium supply unit are all consumed;

FIG. 8A illustrates exemplary signals, which are generated by an optical sensor of the integrated sensing unit according to an exemplary embodiment until the printing media of the large size in the printing medium supply unit are all consumed, over time;

FIG. 8B illustrates exemplary signals, which are generated by the optical sensor of the integrated sensing unit according to an exemplary embodiment until the printing media of the small size in the printing medium supply unit are all consumed, over time;

FIGS. 9A and 9B illustrate an exemplary integrated sensing unit when a printing medium supply unit is empty;

FIG. 10 illustrates an exemplary integrated sensing unit when a printing medium is supplied to the printing medium supply unit;

FIG. 11 illustrates an exemplary e integrated sensing unit if a printing medium of a large size is picked up;

FIG. 12 illustrates an exemplary integrated sensing unit when the picking up of the printing medium of the large size is completed;

FIG. 13 illustrates an exemplary integrated sensing unit if a printing medium of a small size is picked up;

FIG. 14 illustrates an exemplary integrated sensing unit when printing media in the printing medium supply unit are all consumed;

FIG. 15A illustrates exemplary signals, which are generated by an optical sensor of the integrated sensing unit according to an exemplary embodiment until the printing media of a large size in the printing medium supply unit are all consumed, over time; and

FIG. 15B illustrates exemplary signals, which are generated by the optical sensor of the integrated sensing unit according to an exemplary embodiment until the printing media of a small size in the printing medium supply unit are all consumed, over time.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

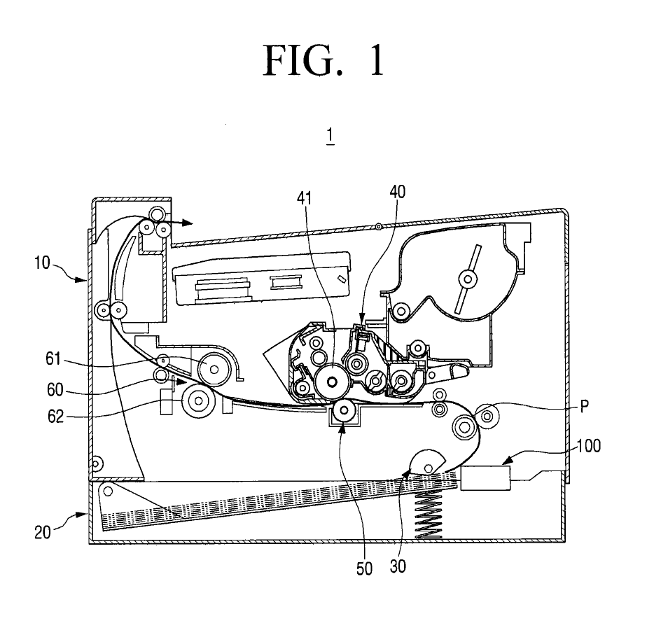

Referring to FIG. 1, an image forming apparatus 1 includes a main body 10 and a printing medium supply unit 20 that may be detachably connected to a lower portion of the main body 10. A pickup unit 30, a developing unit 40 having an image holding member 41, a transfer unit 50, and a fusing unit 60 may be within the main body 10.

Referring to a printing medium conveyance path P, printing media in the printing medium supply unit 20 may be moved into the main body 10 by the pickup unit 30 sheet by sheet. Each sheet of the printing media moved into the main body 10 may receive a developer image when passing through a transfer-nip between the image holing member 41 and the transfer unit 50, and go through image fusing when passing through a fusing-nip between a heat roller 61 and a pressure roller 62 of the fusing unit 60, and then discharged out of the main body 10.

The image forming apparatus 1 may include a control unit (not shown) to control operations of its elements.

As illustrated in FIG. 1, the image forming apparatus 1 includes an integrated sensing unit 100 that may be disposed in the proximity of the printing medium supply unit 20, e.g., in the proximity of the pickup unit 30. The integrated sensing unit 100 senses a presence/absence of a printing medium in the printing medium supply unit and a size of a picked-up printing medium, collectively. The control unit determines a presence/absence of a printing medium in the printing medium supply unit and a size of a picked-up printing medium based on a signal provided by the integrated sensing unit 100.

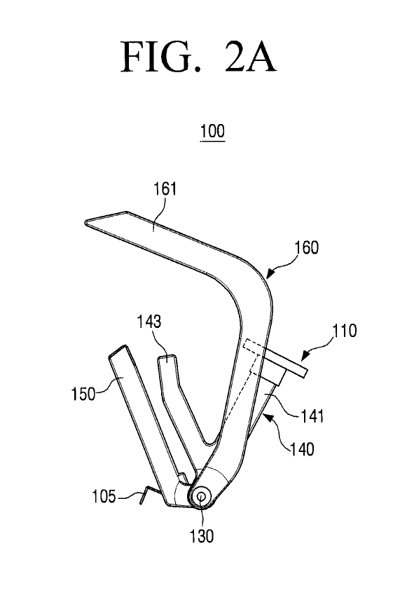

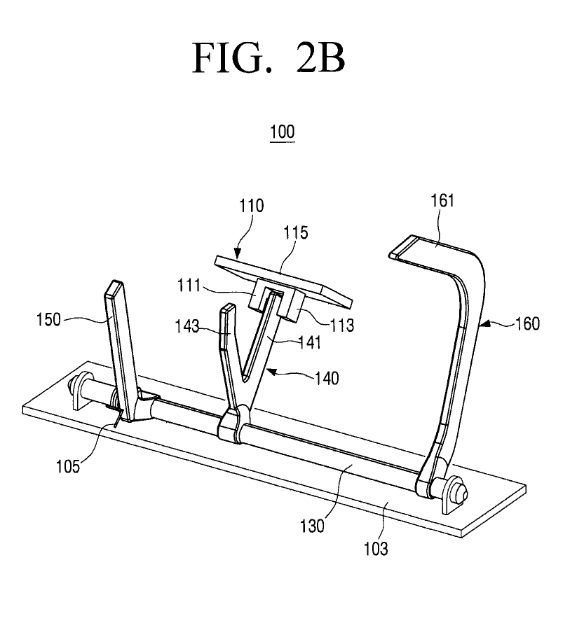

Referring to FIGS. 2A and 2B, the integrated sensing unit 100 includes an optical sensor 110 and an actuator 120.

The optical sensor 110 includes a light emitting part 111, a light receiving part 113, and a support substrate 115. The support substrate 115 may be fixed in the image forming apparatus 1 as a printed circuit board and may have the light emitting part 111 and the light receiving part 113 mounted thereon. The light emitting part 111 and the light receiving part 113 may be disposed opposite each other and the light emitting part 111 emits light (for example, infrared ray) toward the light receiving part 113.

If the light receiving part 113 receives light from the light emitting part 111, the optical sensor 110 generates an ON signal, and, if the light receiving part 113 does not receive light from the light emitting part 111, the optical sensor 110 generates an OFF signal. The signal generated by the optical sensor 110 may be provided to a control as an electric signal.

The actuator 120 includes a shaft member 130, a light blocking member 140, a first contact member 150, and a second contact member 160.

The shaft member 130 may be formed in a rod shape and mounted on a support member 103 formed in the image forming apparatus 1, for example, to be rotatable in both directions. The shaft member 130 includes an elastic member 105 to provide elastic force of a rotation direction (e.g., in a counter-clockwise direction in FIG. 2B) thereto. The elastic member 105 may be a torsion spring according to an exemplary embodiment.

The light blocking member 140 may be mounted on the shaft member 130 to be rotated along with the shaft member 130, and positioned between the first contact member 150 and the second contact member 160 on the shaft member 130. The light blocking member 140 includes a first blocking portion 141 and a second blocking portion 143. The first blocking portion 141 and the second blocking portion 143 form an acute angle therebetween so that the light blocking member 140 has an approximate ‘V’ shape.

If a free end of the first blocking portion 141 and a free end of the second blocking portion 143 is positioned between the light emitting part 111 and the light receiving part 113 of the optical sensor 110 as the shaft member 130 is rotated, light to be received by the light receiving part 113 is blocked and thus the optical sensor 110 generates an OFF signal. On the other hand, if the free end of the first blocking portion 141 and the free end of the second blocking portion 143 is not positioned between the light emitting part 111 and the light receiving part 113 of the optical sensor 110, the light receiving part 113 is allowed to receive light and thus the optical sensor 110 generates an ON signal.

The first contact member 150 is mounted on the shaft member 130 to be rotated along with the shaft member 130, and is disposed on a left end of the shaft member 130 as illustrated in FIG. 2B. The first contact member 150 is provided to sense the presence/absence of printing media in the printing medium supply unit 20, and is rotated in one direction (for example, in a clockwise direction in FIG. 2B) by contact pressure of the printing media if the printing media are contained in the printing medium supply unit 20.

The second contact member 160 may be mounted on the shaft member 130 to be rotated along with the shaft member 130, and may be disposed on a right end of the shaft member 130 as illustrated in FIG. 2B. The second contact member 160 has a free end (contact end) 161 oriented toward the printing medium supply unit 20. The second contact member 160 may be provided to sense a size (width) of a printing medium picked up from the printing medium supply unit 20. If a size of a picked-up printing medium is larger than or equal to a pre-defined size, the second contact member 160 may be rotated in one direction (for example, in a clockwise direction in the FIG. 2B) by contact pressure of the printing medium.

An operation of an exemplary integrated sensing unit 100 is discussed with reference to FIGS. 2A to 8B.

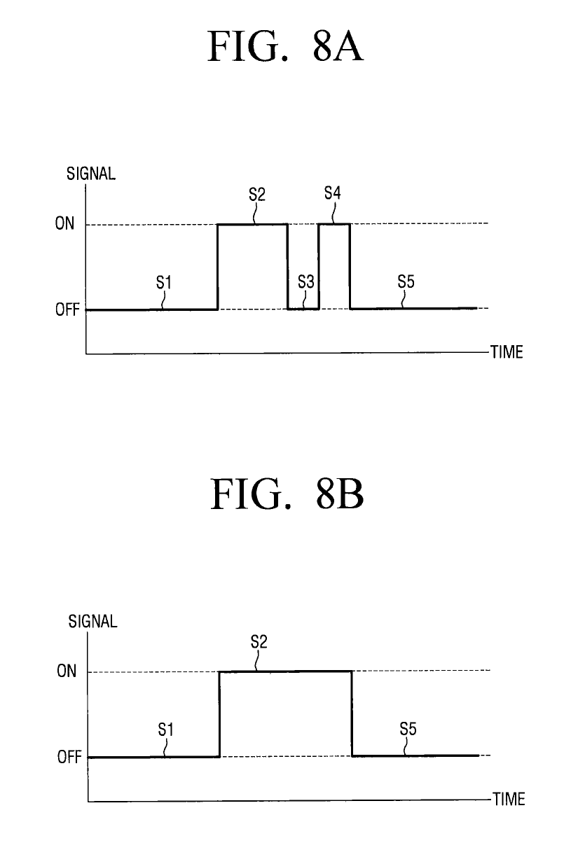

Referring to FIGS. 2A and 2B, if printing media does not exist in the printing medium supply unit 20, that is, if the printing medium supply unit 20 is empty, the light blocking member 140 may be positioned in a first position. In the first position, the free end of the first blocking portion 141 may be positioned between the light emitting part 111 and the light receiving part 113 of the optical sensor 110. Since the first blocking portion 141 of the light blocking member 140 blocks light to be received by the light receiving part 113 when the light blocking member 140 is positioned in the first position, the optical sensor 110 generates an OFF signal (S1 in FIG. 8A or S1 in FIG. 8B).

If the OFF signal (S1) is retained longer than a pre-defined first reference time, the control unit (not shown) determines that the printing medium supply unit 20 is empty. For example, if the first reference time is 3 seconds and the OFF signal (S1) may be retained more than 3 seconds, the control unit determines that the printing medium supply unit 20 is empty.

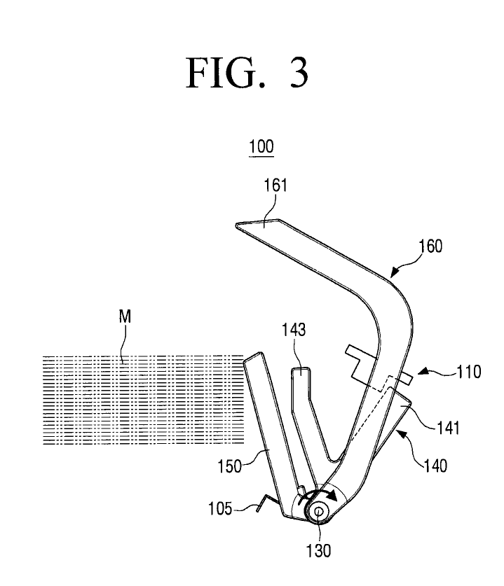

Referring to FIG. 3, if printing media (M) are supplied to the printing medium supply unit 20, the first contact member 150 of the actuator 120 may be rotated by a predetermined angle in one rotation direction (in a clockwise direction in the drawing) by contact pressure of the printing media (M), so that the light blocking member 140 is positioned in a second position. If the light blocking member 140 is positioned in the second position, the optical sensor 110 may be positioned between the first blocking portion 141 and the second blocking portion 143 of the light blocking member 140. Accordingly, since the light blocking member 140 does not block light to be received by the light receiving part 113 of the optical sensor 110, the optical sensor 110 generates an ON signal (S2 in FIG. 8A or S2 in FIG. 8B).

If the ON signal (S2) is received from the optical sensor 110, the control unit determines that printing media exist in the printing medium supply unit 20.

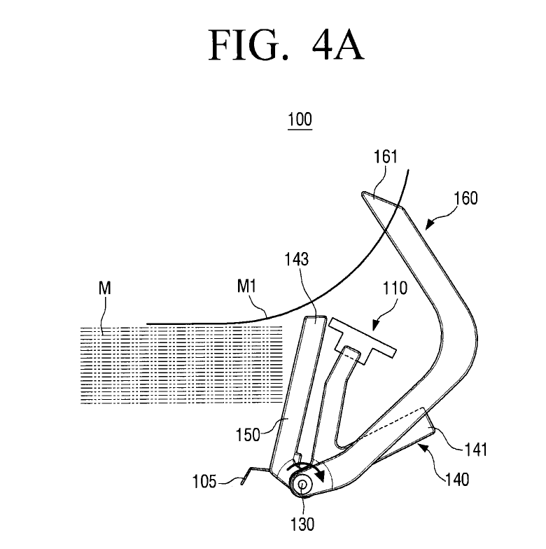

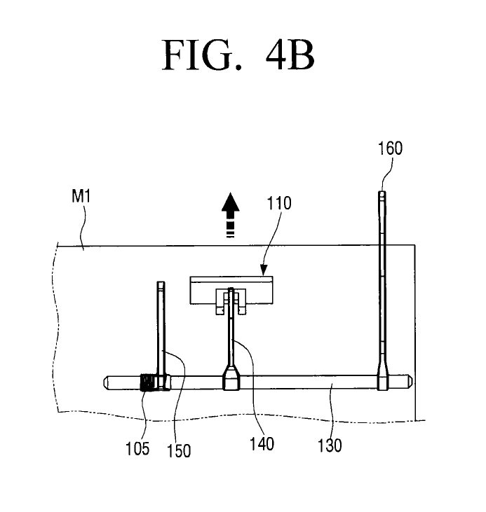

Referring to FIGS. 4A and 4B, if a printing medium M1 larger than a pre-defined size is picked up from the printing medium supply unit 20, the second contact member 160 is rotated by a predetermined angle in one direction (for example, in a clockwise direction in the drawing) by contact pressure of the picked-up printing medium, so that the light blocking member 140 is positioned in a third position. The printing medium M1 larger than the pre-defined size (that is, a large size printing medium) may be A4 paper or letter paper, for example. If the light blocking member 140 is positioned in the third position, the free end of the second blocking portion 143 may be positioned between the light emitting part 111 and the light receiving part 113 of the optical sensor 110. Since light to be received by the light receiving part 113 is blocked, the optical sensor 110 generates an OFF signal (S3 in FIG. 8A).

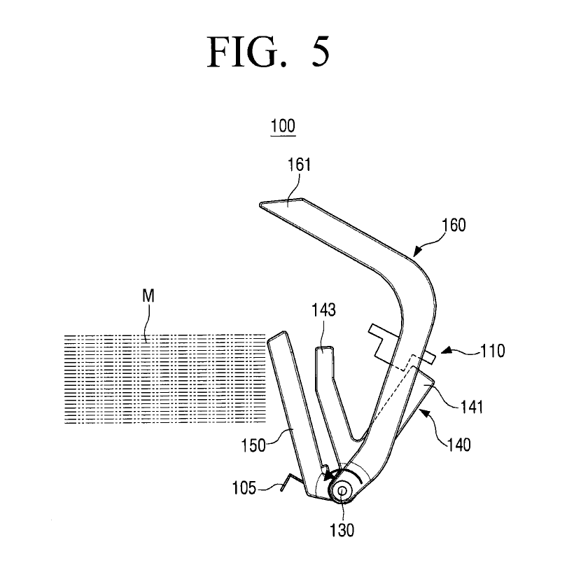

Referring to FIG. 5, if picking up of one sheet of the large size printing medium (M1) is completed, the light blocking member 140 is returned to the second position (see, for example, FIG. 3), which is the position before the printing medium is picked up, from the third position by counter clock wise direction elastic force of the elastic member 105. If the light blocking member 140 is positioned in the second position, the optical sensor 110 generates an ON signal (S4 in FIG. 8A) as described above.

If a plurality of sheets of the large size printing medium (M1) are continuously picked up, the light blocking member 140 of the actuator 120 may be positioned in the third position (see FIG. 4A) and the second position (see FIG. 5) alternately. The optical sensor 110 generates the OFF signal (S3) and the ON signal (S4) alternately and repeatedly.

If the optical sensor 110 generates the OFF signal (S3), based on a pick-up of large size printing medium M1 and the OFF signal (S3) is retained shorter than a pre-defined second reference time, the control unit determines that the picked-up printing medium M1 is a large size printing medium. The second reference time may be set to be shorter than or equal to the first reference time that is set to determine the presence/absence of a printing medium. The first and the second reference times may be set based on the OFF signal (S3) generated when the printing medium (M1) is picked up being retained for a time shorter than that of the OFF signal (S1 in FIG. 8) generated when the printing medium supply unit 20 is empty. For example, if the first reference time is 3 seconds, the second reference time may be set to 1 second.

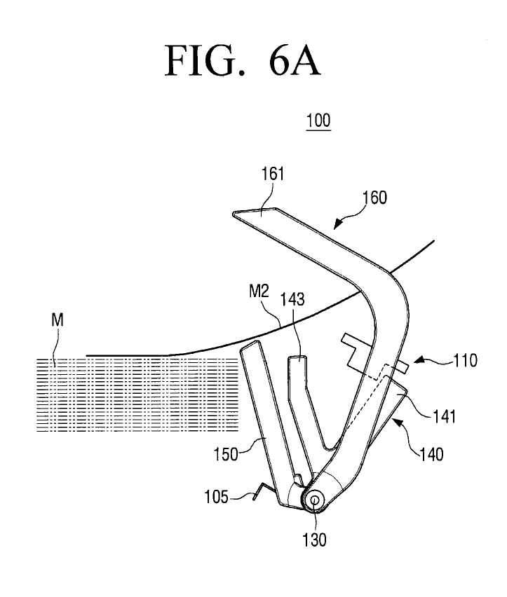

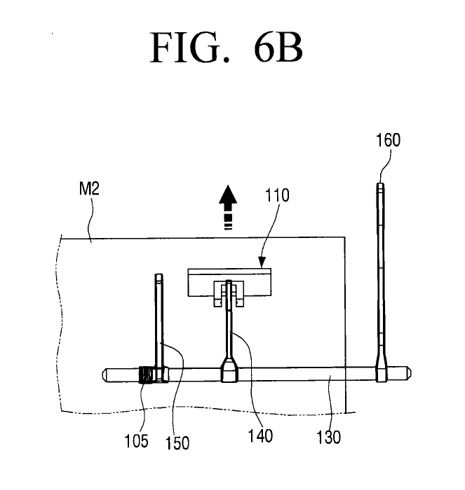

Referring to FIGS. 6A and 6B, if a printing medium M2 smaller than the pre-defined size (that is, a small size printing medium) is picked up from the printing medium supply unit 20, the picked-up printing medium does not contact the second contact member 160. That is, when the large size printing medium M1 is picked up, the printing mediums” right end presses the second contact member 160 in contact with the second contact member 160. However, since the small size printing medium M2 has a narrow width as illustrated in FIG. 6B, the printing medium M2 does not contact the second contact member 160. The small size printing medium M2 may be a printing medium smaller than B5.

Accordingly, when the small size printing medium M2 is picked up, the light blocking member 140 of the actuator 120 is retained in the second position illustrated, for example, in FIG. 3. Accordingly, when the small size printing medium M2 is picked up, the optical sensor 110 continues generating the ON signal (S2 in FIG. 8B) without changing the signal.

If the optical sensor 110 continues generating the ON signal (S2) without generating an OFF signal when the printing medium is picked up, the control unit determines that the picked-up printing medium is a small size printing medium.

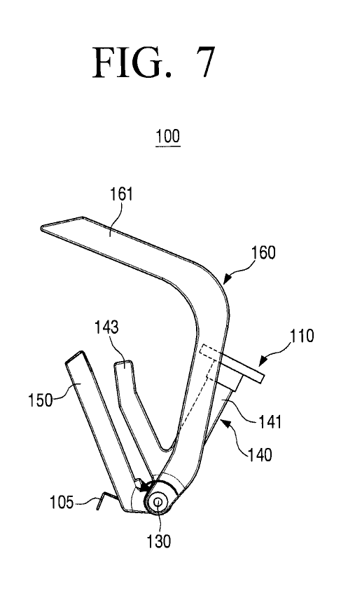

Referring to FIG. 7, if the printing media in the printing medium supply unit 20 are all consumed and thus the printing medium supply unit 20 is empty, the contact pressure of the printing media toward the first contact member 150 is released and thus the actuator 120 is rotated by a predetermine angle in a counter clockwise direction by the elastic force of the elastic member 105. Accordingly, the light blocking member 140 of the actuator 120 is moved to the first position from the second position. Since the light to be received by the light receiving part 113 is blocked by the first blocking portion 141, the optical sensor 110 generates an OFF signal (for example, S5 in FIG. 8A or S5 in FIG. 8B).

If the OFF signal (S5) is retained more than the first reference time (for example, 3 seconds), the control unit determines that the printing medium supply unit 20 is empty.

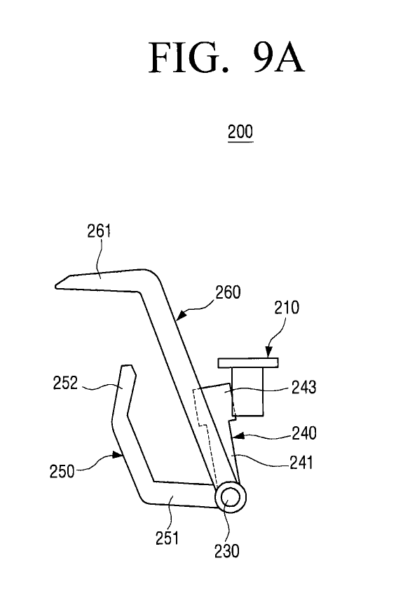

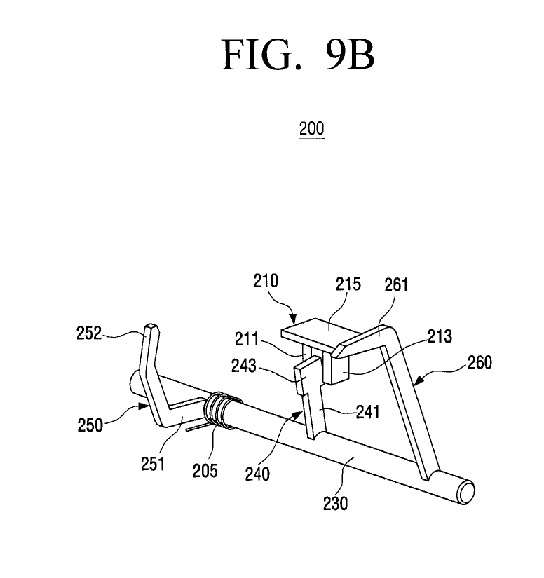

An integrated sensing unit 200 according to an exemplary embodiment will be explained with reference to FIGS. 9A to 15B.

Referring to FIGS. 9A and 9B, the integrated sensing unit 200 includes an optical sensor 210 and an actuator 220.

The optical sensor 210 includes a light emitting part 211, a light receiving part 213, and a support substrate 215. The light emitting part 211, the light receiving part 213, and the support substrate 215 are the substantially the same as the light emitting part 111, the light receiving part 113, and the support substrate 115 of the optical sensor 110 according to a first exemplary embodiment.

The actuator 220 includes a shaft member 230, a light blocking member 240, a first contact member 250, and a second contact member 260.

The shaft member 230 may have a rod shape and mounted on the support member (not shown) provided in the image forming apparatus 1 to be rotatable in both directions. The shaft member 23 includes an elastic member 205 to provide elastic force of one rotation direction (, for example, a counter clockwise direction in FIG. 9B) thereto. The elastic member 205 may be a torsion spring.

The light blocking member 240 may be mounted on the shaft member 230 to be rotated along with the shaft member 230, and positioned between the first contact member 250 and the second contact member 260 on the shaft member 230. In comparison to the V-shaped light blocking member 140 (see FIG. 2B) of a first exemplary embodiment, the light blocking member 240 is a single member. The light blocking member 240 includes a body portion 241 and a blocking portion 243 integrally formed with the body portion 241, and the blocking portion 243 has a wider width than that of the body portion 241 to facilitate blocking of light.

If the blocking portion 243 of the light blocking member 240 is positioned between the light emitting part 211 and the light receiving part 213 of the optical sensor 210 as the shaft member 230 is rotated, light to be received by the light receiving part 213 is blocked and the optical sensor 210 generates an OFF signal. On the other hand, if the blocking portion 243 of the light blocking member 240 is not positioned between the light emitting part 211 and the light receiving part 213 of the optical sensor 210, the light receiving part 213 is allowed to receive light and the optical sensor 210 generates an ON signal.

The first contact member 250 is mounted on the shaft member 230 to be rotated along with the shaft member 230 and is disposed on a left end of the shaft member 230 as illustrated in FIG. 9B. The first contact member 250 includes a connection portion 251 connected to the shaft member 230 and a contact portion 252 contacting printing media. The connection portion 251 and the contact portion 252 have an angle slightly larger than 90° therebetween so that the first contact member 250 has an approximate ‘L’ shape. The first contact member 250 is provided to determine whether printing media exist in the printing medium supply unit 20 and may be rotated in one direction (for example, in a clockwise direction in FIG. 9B) by contact pressure of the printing media if the printing media are contained in the printing medium supply unit 20.

The second contact member 260 may be mounted on the shaft member 230 to be rotated along with the shaft member 230 and disposed on a right end of the shaft member 230 as illustrated in FIG. 9B. The second contact member 260 has a free end (contact end) 261 oriented toward the printing medium supply unit 20. The second contact member 260 may be provided to sense a size (width) of a printing medium picked up from the printing medium supply unit 20 and may be rotated in one direction (for example, in a clockwise direction in FIG. 9B) by contact pressure of a picked-up printing medium if the printing medium is larger than a pre-defined size.

With reference to FIGS. 9A to 15B, an exemplary operation of the integrated sensing unit 200 according to the second exemplary embodiment is described.

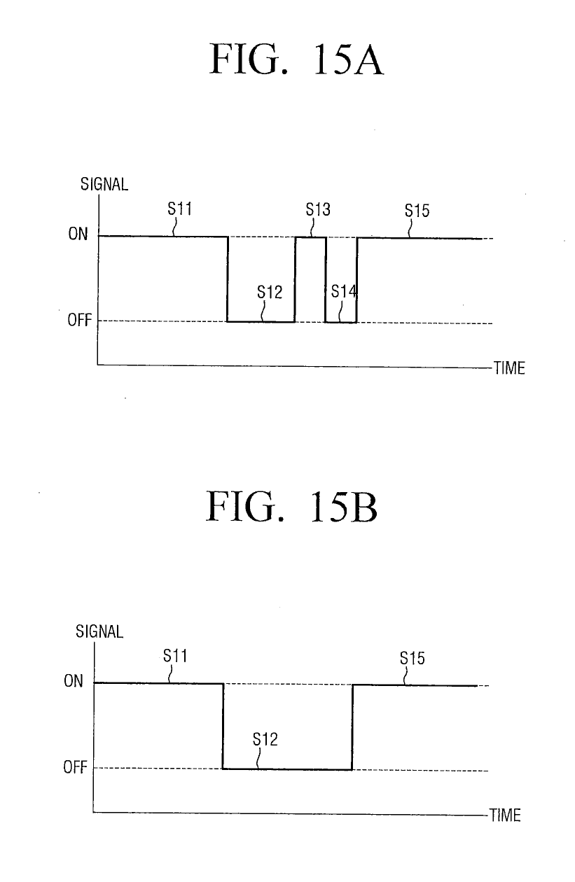

Referring to FIGS. 9A and 9B, if printing media do not exist in the printing medium supply unit 20, that is, if the printing medium supply unit 20 is empty, the light blocking member 240 is positioned in a first position. In the first position, the blocking portion 243 of the light blocking member 240 is deviated from the optical sensor 210. That is, in the first position, the blocking portion 243 of the light blocking member 240 is not positioned between the light emitting part 211 and the light receiving part 213 of the optical sensor 210. Since the blocking portion 243 of the light blocking member 240 does not block light to be received by the light receiving part 213, the optical sensor 210 generates an ON signal (S11 in FIG. 15A or S11 in FIG. 15B).

If the ON signal (S1) is retained longer than a pre-defined first reference time, the control unit (not shown) determines that the printing medium supply unit 20 is empty. For example, if the first reference time is 3 seconds and the OFF signal is retained more than 3 seconds, the control unit determines that the printing medium supply unit 20 is empty.

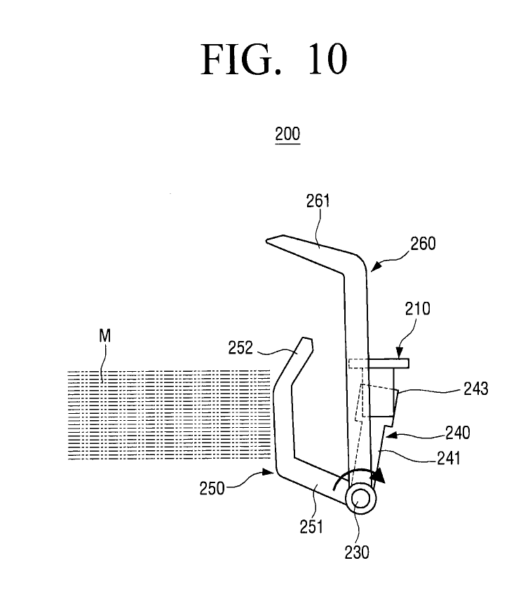

Referring to FIG. 10, if printing media are supplied to the printing medium supply unit 20, the first contact member 250 of the actuator 220 is rotated by a predetermined angle in one rotation direction (in a clockwise direction in the drawing) by contact pressure of the printing media, so that the light blocking member 240 is positioned in a second position. If the light blocking member 240 is positioned in the second position as described above, the blocking portion 243 of the light blocking member 240 is positioned between the light emitting part 211 and the light receiving part 213 of the optical sensor 210 and thus blocks light to be received by the light receiving part 213. Accordingly, the optical sensor 210 generates an OFF signal (S12 in FIG. 15A or S12 in FIG. 15B).

If the OFF signal (S2) is received from the optical sensor 210, the control unit determines that the printing media exists in the printing medium supply unit 20.

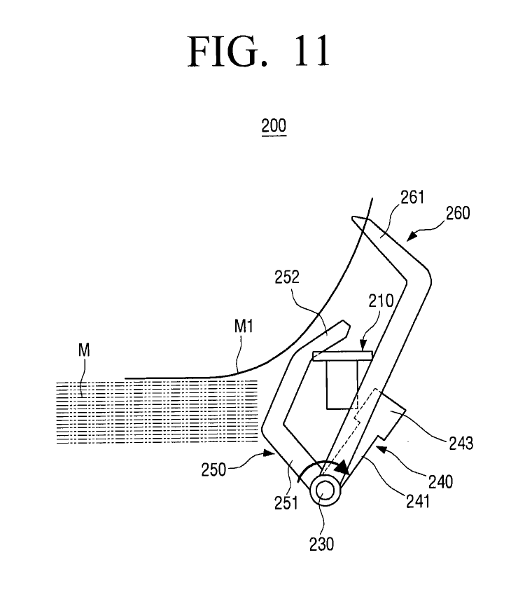

Referring to FIG. 11, if a printing medium M1 larger than a pre-defined size is picked up from the printing medium supply unit 20, the second contact member 260 is rotated by a predetermined angle in one direction (, for example, in a clockwise direction in the drawing) by contact pressure of the picked up printing medium, so that the optical blocking member 240 is positioned in a third position. The printing medium M1 larger than the pre-defined size (that is, a large size printing medium) may be A4 paper or letter paper, for example. If the light blocking member 240 is positioned in the third position, the blocking portion 243 of the light blocking member 240 is deviated from the optical sensor 210. Accordingly, since light to be received by the light receiving part 213 is blocked by the light blocking member 240, the optical sensor 210 generates an ON signal (S13 in FIG. 15A).

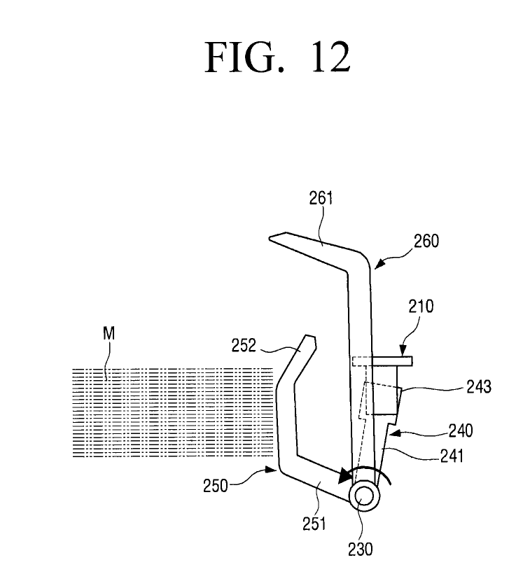

Referring to FIG. 12, if picking up of one sheet of the large size printing medium M1 is completed, the light blocking member 240 is returned to the second position (see FIG. 10), which is the position before the printing medium is picked up, by counter clockwise direction elastic force of the elastic member 205. If the light blocking member 240 is positioned in the second position, the optical sensor 210 generates an OFF signal (S14 in FIG. 15A).

If several sheets of the large size printing medium M1 are continuously picked up, the light blocking member 240 of the actuator 220 is positioned in the third position (see FIG. 11) and the second position (see FIG. 12) alternately. The optical sensor 210 generates the ON signal (S13) and the OFF signal (S14) alternately and repeatedly.

If the optical sensor 210 generates the ON signal (S13) by the picked-up large size printing medium M1 and if the ON signal (S13) is retained for less than a pre-defined second reference time, the control unit determines that the picked up printing medium M1 is a large size printing medium. The second reference time may be set to be shorter than or equal to the first reference time to determine presence/absence of a printing medium. For example, if the first reference time is 3 seconds, the second reference time may be set to 1 second.

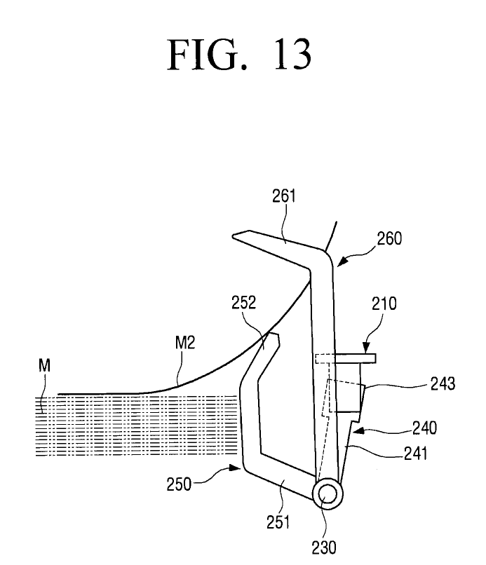

Referring to FIG. 13, if a printing medium M2 smaller than a pre-defined size (that is, a small size printing medium) is picked up from the printing medium supply unit 20, the picked-up printing medium does not contact the second contact member 260. That is, if the large size printing medium M1 is picked up, its right end presses the second contact member 260 in contact with the second contact member 260, whereas, if the small size printing medium M2 is picked up, the printing medium M2 does not contact the second contact portion 260 since its width is short. The small size printing medium M2 may be a printing medium smaller than B5.

Accordingly, if the small size printing medium M2 is picked up, the light blocking member 240 of the actuator 220 is retained in the second position explained in FIG. 10. Accordingly, if the small size printing medium M2 is picked up, the optical sensor 210 continues generating the OFF signal (S12 in FIG. 15B) without changing the signal.

If the optical sensor 210 continues generating the OFF signal without generating an ON signal when the printing medium is picked up, the control unit determines that the picked-up printing medium is a small size printing medium.

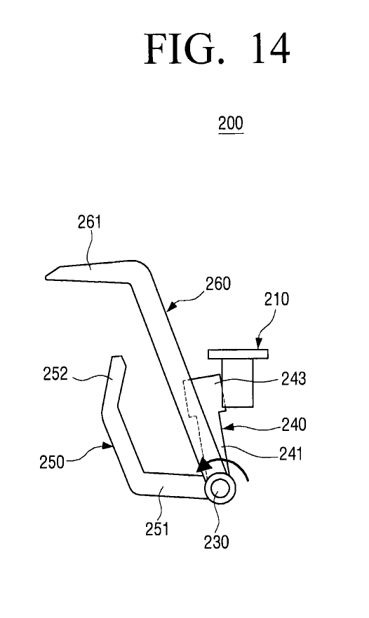

Referring to FIG. 14, if the printing media in the printing medium supply unit 20 are all consumed and the printing medium supply unit 20 is empty, the contact pressure of the printing media toward the first contact member 250 is released and thus the actuator 220 is rotated by a predetermined angle, for example, in a counter clockwise direction by the elastic force of the elastic member 205. Accordingly, the light blocking member 240 of the actuator 220 is rotated from the second position to the first position. Since light to be received by the light receiving part 213 is not blocked by the light blocking member 240, the optical sensor generates an ON signal (S15 in FIG. 15A or S15 in FIG. 15B).

If the ON signal (S15) is retained more than the first reference time (for example, 3 seconds), the control unit determines that the printing medium supply unit 20 is empty.

The integrated sensing unit 100 according to a first exemplary embodiment can sense whether printing media exist in the printing medium supply unit 20 and a size of a picked-up printing medium using only one optical sensor 110 and only one actuator 120. Likewise, the integrated sensing unit 200 according to a second exemplary embodiment can also sense whether printing media exist in the printing medium supply unit 20 and size of a picked-up printing medium using only one optical sensor 210 and only one actuator 220.

Accordingly, in comparing a related-art apparatus which includes a plurality of sensors and a plurality of actuators to sense a presence/absence of a printing medium and a size of a picked-up printing media, an exemplary embodiment of an image forming apparatus of the present disclosure requires only one sensor and only one actuator, so that a manufacturing cost can be relatively decreased and the image forming apparatus can be more easily miniaturized.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. An image forming apparatus which comprises an integrated sensing unit which senses presence/absence of paper in a printing medium supply unit and a size of paper picked up from the printing medium supply unit, collectively,
wherein the integrated sensing unit comprises:
an optical sensor which comprises a light emitting part and a light receiving part to receive light emitted from the light emitting part; and
an actuator which selectively blocks light to be received by the light receiving part,
wherein the actuator comprises:
a shaft member elastically supported in one rotation direction;
a light blocking member mounted on the shaft member and positioned between the light emitting part and the light receiving part; and
a first contact member and a second contact member distanced from each other on the shaft member,
wherein the first contact member rotates the light blocking member on the shaft member in the other rotation direction opposite to the one rotation direction by contact with paper supplied to the printing medium supply unit, thereby reversing a light receiving state of the light receiving part,
wherein the second contact member further rotates the light blocking member on the shaft member in the other rotation direction by contact with paper of a size larger than a pre-defined size picked up from the printing medium supply unit, thereby reversing the light receiving state of the light receiving part.

2. The image forming apparatus as claimed in claim 1, further comprising a control unit that determines presence/absence of paper and a size of paper based on a signal provided by the optical sensor.

3. The image forming apparatus as claimed in claim 2, wherein the light blocking member is positioned in a first position if the printing medium supply unit is empty, is moved from the first position to a second position if the first contact member contacts paper supplied to the printing medium supply unit, and is moved from the second position to a third position if the second contact member contacts paper of a size larger than the pre-defined size picked up from the printing medium supply unit,
wherein a light receiving state of the light receiving part when the light blocking member is positioned in the second position is the reverse of a light receiving state of the light receiving part when the light blocking member is positioned in the first position and the third position.

4. The image forming apparatus as claimed in claim 3, wherein the paper of the size larger than the pre-defined size is A4 paper or letter paper.

5. The image forming apparatus as claimed in claim 3, wherein the light blocking member is positioned to block light to be received by the light receiving part when being positioned in the first position and the third position, and is positioned to allow light to be received by the light receiving part when being positioned in the second position.

6. The image forming apparatus as claimed in claim 5, wherein, if an OFF signal generated by the optical sensor is retained longer than a first reference time, the control unit determines that the printing medium supply unit is empty.

7. The image forming apparatus as claimed in claim 6, wherein, if an OFF signal generated by the optical sensor is retained for less than a second reference time, the control unit determines that paper picked up from the printing medium supply unit is paper of a size larger than the pre-defined size.

8. The image forming apparatus as claimed in claim 7, wherein the second reference time is shorter than the first reference time.

9. The image forming apparatus as claimed in claim 5, wherein the light blocking member comprises:
a first blocking portion which is positioned between the light emitting part and the light receiving part when the light blocking member is positioned in the first position, and
a second blocking portion which is positioned between the light emitting part and the light receiving part when the light blocking member is positioned in the third position.

10. The image forming apparatus as claimed in claim 9, wherein, if the light blocking member is positioned in the second position, the optical sensor is positioned between the first blocking portion and the second blocking portion.

11. The image forming apparatus as claimed in claim 9, wherein the first blocking portion and the second blocking portion form an acute angle therebetween.

12. The image forming apparatus as claimed in claim 3, wherein the light blocking member is positioned to allow light to be received by the light receiving part when being positioned in the first position and the third position, and is positioned to block light to be received by the light receiving part when being positioned in the second position.

13. The image forming apparatus as claimed in claim 12, wherein the light blocking member comprises:
a body portion which is connected to the shaft member, and
a blocking portion which extends from the body portion and is positioned between the light emitting part and the light receiving part only if the light blocking member is positioned in the second position.

14. The image forming apparatus as claimed in claim 12, wherein, if an ON signal generated by the optical sensor is retained longer than a first reference time, the control unit determines that the printing medium supply unit is empty.

15. The image forming apparatus as claimed in claim 13, wherein, if an ON signal generated by the optical sensor is retained shorter than a second reference time, the control unit determines that paper picked up from the printing medium supply unit is paper of a size larger than the pre-defined size.

16. The image forming apparatus as claimed in claim 15, wherein the second reference time is shorter than the first reference time.

17. The image forming apparatus as claimed in claim 1, wherein the light blocking member is disposed between the first contact member and the second contact member on the shaft member.

18. The image forming apparatus as claimed in claim 17, wherein the light blocking member, the first contact member and the second contact member are integrally formed with the shaft member.

19. An image forming apparatus which comprises an integrated sensing unit which senses presence/absence of paper in a printing medium supply unit and a size of paper picked up from the printing medium supply unit, collectively,
wherein the integrated sensing unit comprises:
an optical sensor which comprises a light emitting part and a light receiving part to receive light emitted from the light emitting part; and
an actuator which selectively blocks light to be received by the light receiving part,
wherein the actuator comprises:
a shaft member elastically supported in one rotation direction;
a light blocking member mounted on the shaft member and positioned between the light emitting part and the light receiving part; and
a first contact member and a second contact member distanced from each other on the shaft member,
wherein the light blocking member is positioned in a first position if the printing medium supply unit is empty, is moved from the first position to a second position if the first contact member contacts paper supplied to the printing medium supply unit, and is moved from the second position to a third position if the second contact member contacts paper picked up from the printing medium supply unit,
wherein the light blocking member blocks light to be received by the light receiving part when being positioned in the first position and the third position, and allows light to be received by the light receiving part when being positioned in the second position.

20. An image forming apparatus which comprises an integrated sensing unit which senses presence/absence of paper in a printing medium supply unit and a size of paper picked up from the printing medium supply unit, collectively,
wherein the integrated sensing unit comprises:
an optical sensor including a light emitting part and a light receiving part; and
an actuator to selectively block light to be received by the light receiving part, wherein the actuator comprises:
a shaft member elastically supported in a rotation direction, and
a light blocking member mounted on the shaft member and positioned between the light emitting part and the light receiving part,
wherein the light blocking member is positioned in a first position if a printing medium supply unit is empty, in a second position if a first contact member contacts paper supplied to a printing medium supply unit, and a third position if a second contact member contacts paper picked up from a printing medium supply unit,
wherein the light blocking member allows light to be received by the light receiving part when positioned in the first position and the third position, and blocks light to be received by the light receiving part when positioned in the second position.
